(19) United States
(12) Patent Application Publication
(10) Pub. No.: US 2002/0143570 A1
(43) Pub. Date: Oct. 3, 2002

(54) Credit card management method, credit card management program, credit card management device

(75) Inventor: Yoshikazu Tobita, Yokohama (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/068,942

(22) Filed: Feb. 11, 2002

(30) Foreign Application Priority Data
Mar. 30, 2001 (JP) 2001-102039

(51) Int. Cl. G06F 17/60

(52) U.S. Cl. 705/1

(57) ABSTRACT

A credit card management device is provided with a first storing unit which stores transaction forms, a second storing unit which stores a credit limit corresponding to the transaction form, a unit which receives the credit card identification information and store identification information together with a credit amount, a unit which extracts the transaction form corresponding to the store identification information from the first storing unit, a unit which extracts credit card identification information and a credit limit corresponding to the transaction form from a second storing unit, and a unit which makes a determination as to whether or not the credit amount is within the credit limit, thus, in an attempt to use a credit card through the Internet or the like, it is possible to use a card through the network without qualms.

### FIELD OF THE INVENTION

The present invention relates to a method which manages the credit limit of a credit card, and also concerns a program, a device and a recording medium used for such a method.

### BACKGROUND OF THE INVENTION

Conventionally, with respect to the credit limit of a credit card, only one credit limit is managed for each credit card.

With respect to the conventional limit of a credit card, only one credit limit is managed for each credit card, therefore, in an attempt to use a credit card on the Internet or the like, those who feel uneasy about the present security technique on the network cannot use a card through the network without qualms, even when the credit amount is small.

### SUMMARY OF THE INVENTION

The present invention has been achieved in order to solve the above problem.

In order to solve the above problem, according to one aspect of the present invention, there is provided a credit card management device comprising, a first storing unit which stores transaction forms corresponding to store identification information, a second storing unit which stores credit card identification information and a credit limit corresponding to the transaction form, a unit which receives the credit card identification information and store identification information together with a credit amount, a unit which extracts the transaction form corresponding to the store identification information from the first storing unit, a unit which extracts credit card identification information and a credit limit corresponding to the transaction form from a second storing unit, and a unit which makes a determination as to whether or not the credit amount is within the credit limit.

Other objects and features of this invention will become understood from the following description with reference to the accompanying drawings.

### BRIEF DESCRIPTION OF THE DRAWINGS

FIG. 1 is a drawing which shows a system construction;

FIG. 2 is a flow chart which shows a service condition registering process;

FIG. 3 is a flow chart which shows a determination process for a service request;

FIG. 4 is a drawing which shows a store DB;

FIG. 5 is a flow chart (No. 1) which shows a service requesting process;

FIG. 6 is a flow chart (No. 2) which shows the service requesting process;

FIG. 7 is a drawing which shows a service condition DB;

FIG. 8 is a drawing which shows service history DB; and

FIG. 9 is a flow chart which shows a store condition registering process.

### DETAILED DESCRIPTIONS

One embodiment of a credit card management method according to the present invention will be explained in detail below with reference to the accompanying drawings.

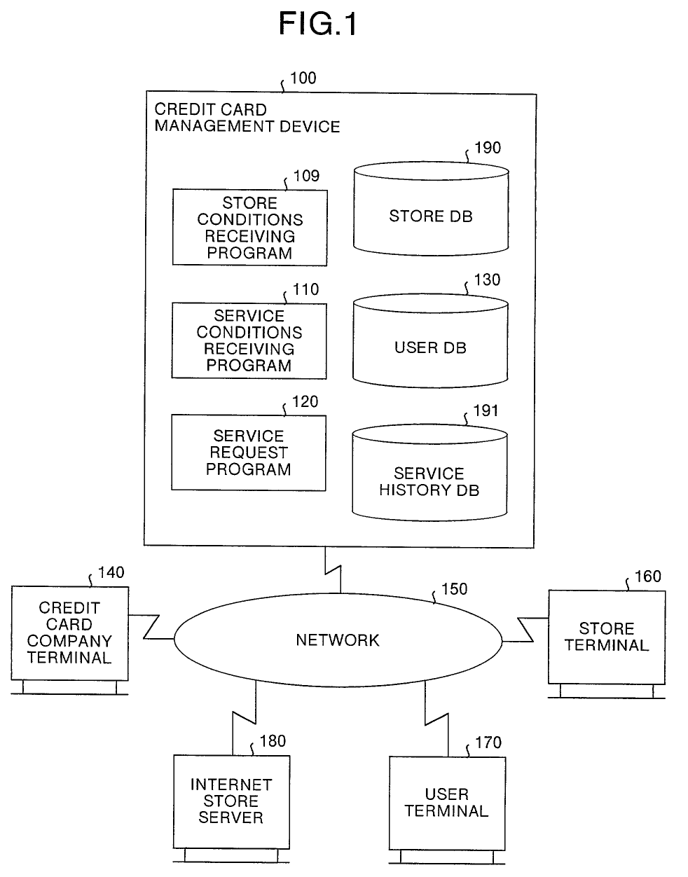

FIG. 1 is a drawing which shows a system construction of the present embodiment. In this figure, it is assumed that to a credit card management device 100 are connected not less than one credit card company terminals 140 that are used by operators of the credit card company, not less than one store terminals 160 that are used by store clerks, not less than one user terminals 170 that are operated by the users, and not less than one Internet store servers 180 that coordinate the user terminals with the credit card management device, all of which are connected to each other through a network 150.

The credit card management device 100, is provided with, three data bases, that is, a store DB190 and a user DB130 as well as a user history DB191 which are placed at a credit card management center of a credit card agent that can be accessed from any of the credit card company terminal, the store terminals and the Internet store servers and which have constituent elements that will be explained later, a program 109 which receives store conditions including a store code and transaction forms as well as fees from an operator of the credit card company, and registers these in the store DB190, a program 110 which receives service conditions including credit card number, name, validity term, password, debit bank, debit account number, normal credit limit and Internet credit limit from an operation of the credit card company, and registers these conditions in the user DB130, and a program 120 which writes service requests including service forms, credit amount money and method of payment, that is, identification information of credit card number, name, date of use and classification on shopping use or credit use, received from a store terminal or an Internet store server, in the user history DB191 by reference to the user DB130 and the store DB190, and then edits the results of use to transmit the resulting information to the store terminal or the internet store server.

The constituent elements held by the store database 190 are store codes and transaction forms as well as fees. The constituent elements held by the user DB130 are the credit card number, name, validity term, pass word, debit bank, debit account number, normal credit limit and Internet credit limit. The constituent elements held by the user history DB191 are the credit card number, and the store codes, as well as service forms, methods of payment and date and time.

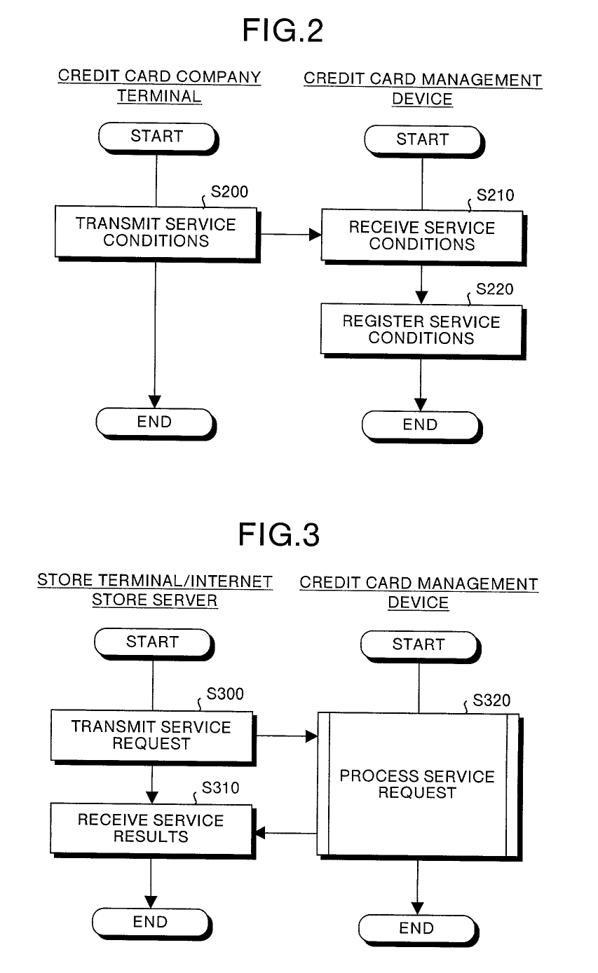

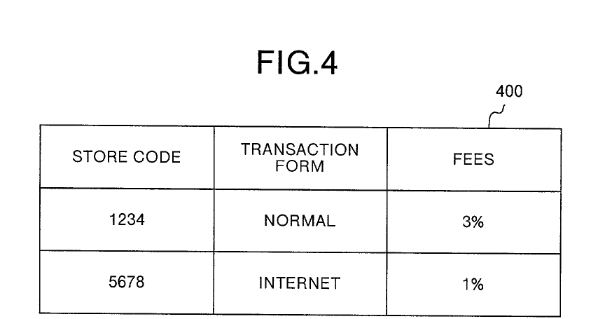

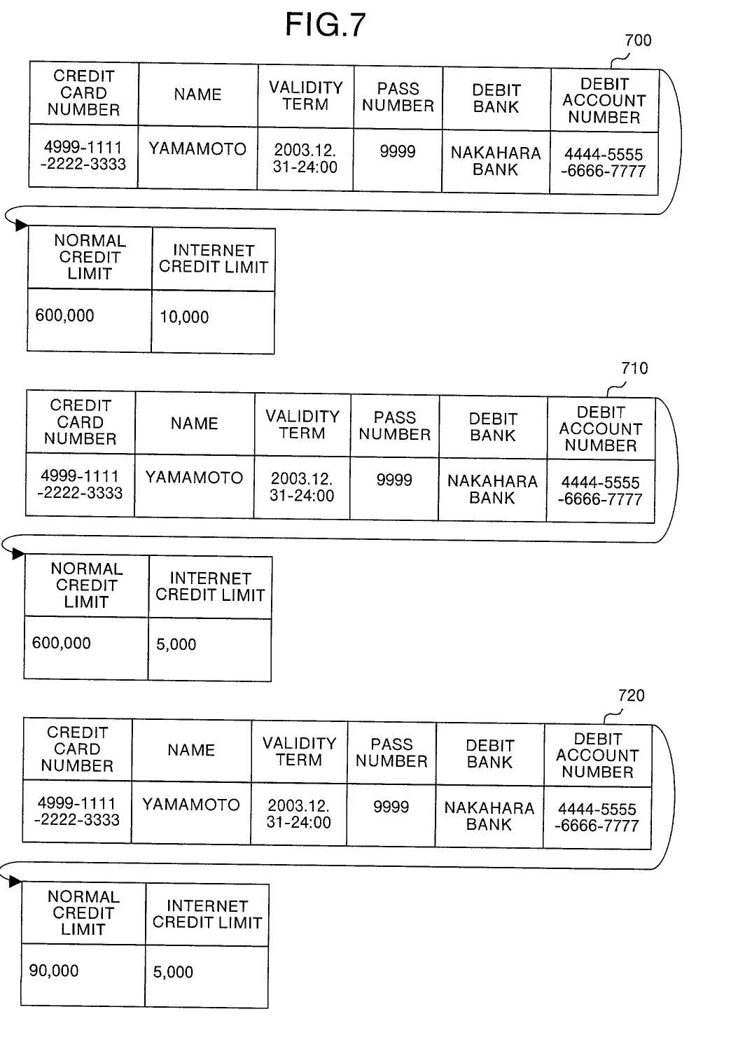

Processes which receive the store conditions and service conditions from an operator of the credit card company, and register these in the store DB190 and the user DB130 will be explained with reference to FIGS. 1 and 9, as well as FIGS. 2, 4 and 7. FIG. 9 is a flow chart that explains the sequence of the store condition registering process, FIG. 2 is a flow chart that explains the sequence of service condition registering processes, FIG. 4 is a drawing which shows a specific change in the contents of the store DB190, and FIG. 7 is a drawing which shows a specific change in the contents of the user DB130.

The operation of the present system when store conditions are received from an operator through a credit card company terminal will be explained with reference to FIG. 9.

When the store conditions of a new credit card dealing store is registered, an operator of the credit card company makes a transmission S900 (store condition transmission) for a request to register the store conditions of the new credit card dealing store in the store DB190 in the present system by using the credit card terminal 140. The information of the store conditions includes a store code and transaction forms as well as fees that have been input by the operator of the credit card company. The present system, which has received the store conditions at S910, registers the store code and information of store conditions including transaction forms as well as fees in the store DB190 at S920. Reference numeral 400 shows the store DB190 when store conditions of two new credit card dealing stores are registered as store codes “1234” and “5678”, “transaction states “normal” and “Internet”, and fees “3%” and “1%”.

The operation of the present system when service conditions are received from an operator through a credit card company terminal will be explained with reference to FIG. 2.

Upon registering the service conditions of a new credit card user, the operator of the credit card company makes a transmission S200 (service condition transmission) for a request to register service conditions of a new credit card user in the user DB130 to the present system by using a credit card company terminal 140. The information of the service conditions includes a credit card number, the name, validity term, pass word, debit bank, debit account number, normal credit limit and Internet credit limit that have been input by the operator of the credit card company. Upon receipt of the service conditions at S210, the present system registers the information of the service conditions including the credit card number, the name, validity term, pass word, debit bank, debit account number, normal credit limit and Internet credit limit in the user DB130 at S220. Reference numeral 700 shows the user DB130 when the service conditions of the new credit card user are registered in the user DB130 as credit card number “4999-1111-2222] 333”, name “Yamamoto”, validity term “2003, 12-31-24:00”, pass number “9999”, debit bank “Nakahara Bank”, debit band account “4444-5555-6666-7777”, normal credit limit “600,000” and Internet credit limit “10,000”.

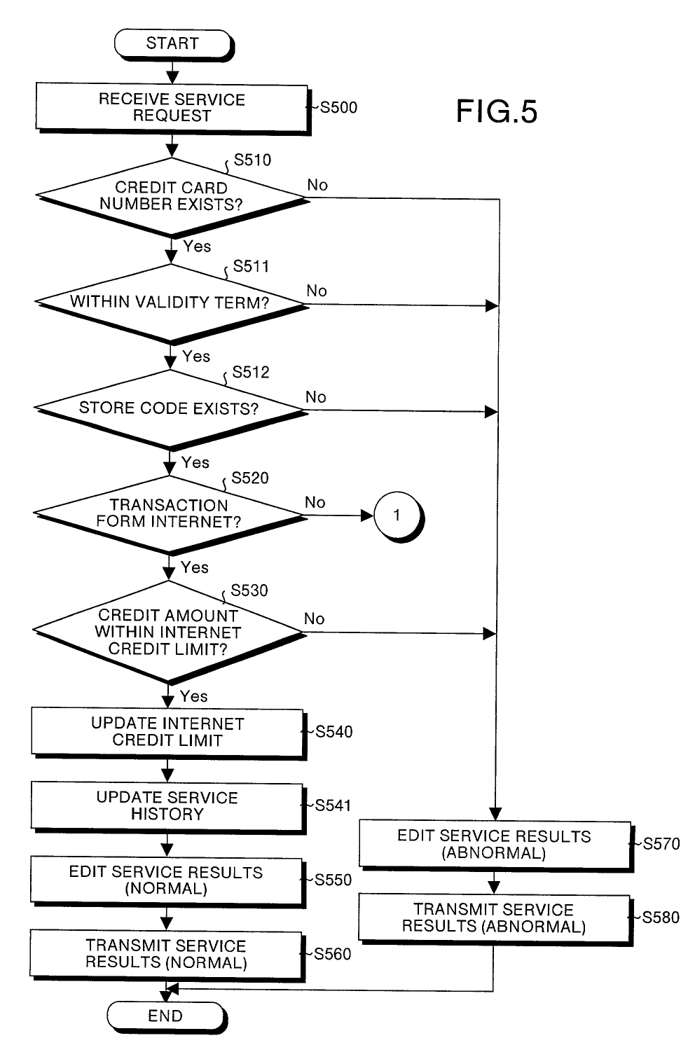

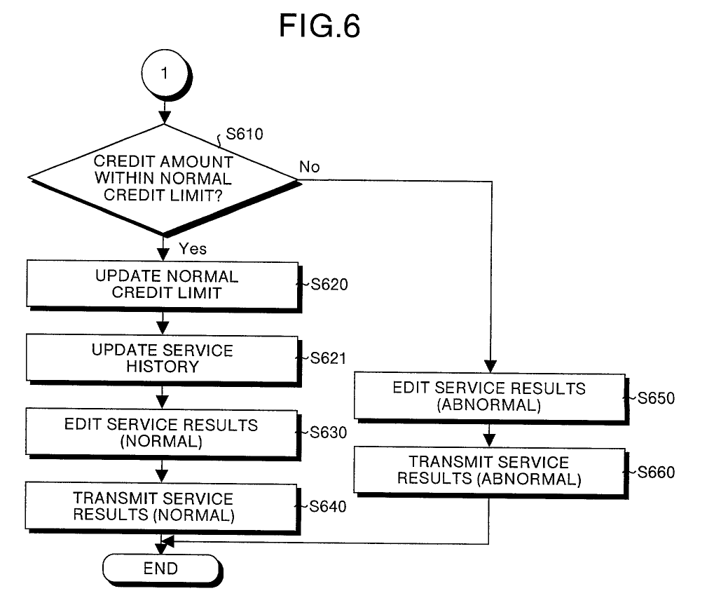

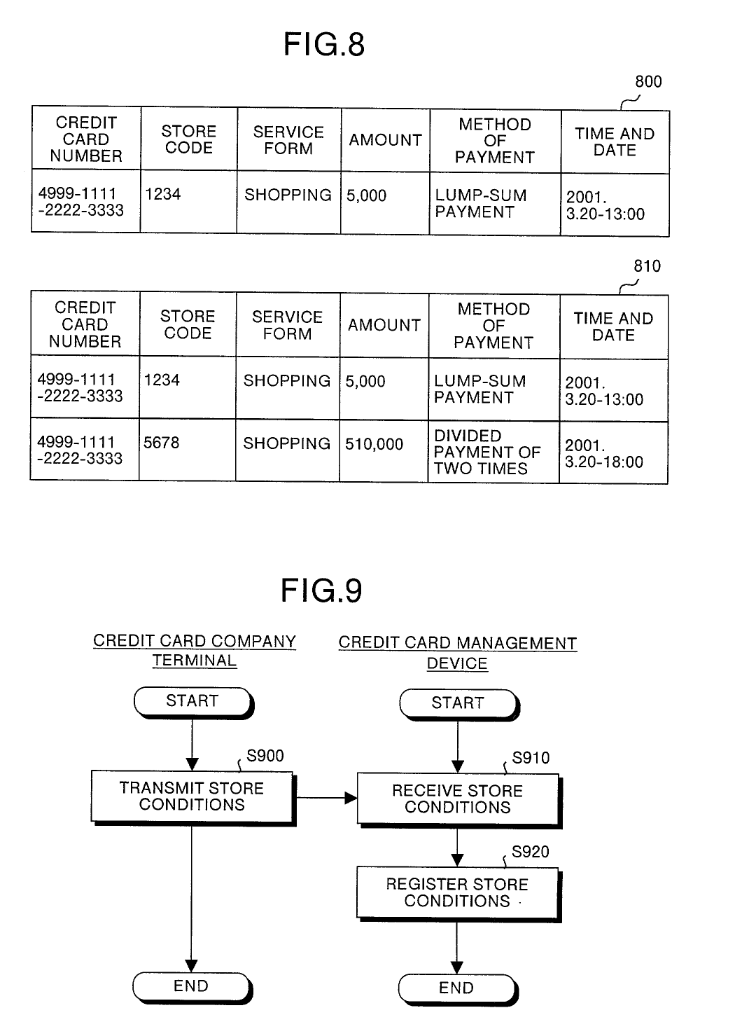

In a state where the store conditions and service conditions have been registered, processes in which, upon receipt of a service request from a store clerk or a user, the service results with respect to the service request are transmitted to the store clerk or the user by reference to the store DB190 and the user DB130 will be explained with reference to FIGS. 1, 3, 5, 6, 7 and 8. FIG. 3 is a flow chart that explains the sequence of service request determining processes, FIGS. 5 and 6 are flow charts of the user request processes, FIG. 7 is a drawing which shows a specific change in the contents of the user DB130 and FIG. 8 is a drawing which shows a specific change in the contents of the user history DB191.

The operation of the present system upon receipt of a service request from a store terminal or Internet store server will be explained with reference to FIG. 3. Here, the operation of the present system after receipt of the service request is common irrespective of the difference in the service request transmission ends, therefore, in this description, first, the respective transmission operations of the service requests will be explained, and the common operation will be then explained.

A user request transmitting operation to the present system when a commodity is purchased using a credit card in a normal store other than those on the Internet will be explained. A store clerk who has received a credit card of a user makes a transmission S310 (service request transmission) for a service request of the credit card to the present system by using the store terminal 160. The information of service request includes a credit card number, name, date of use, store code, service form that is identification information as to shopping use or credit use, credit amount money and method of payment, which have been input by the store clerk through the store terminal 160. At S320, upon receipt of the service request, the present system compares the service request, the store DB190 and the user DB130 with each other, and makes determinations so as to carry out processes which transmit the service results with respect to the service request to the store terminal 160. At S310, upon receipt of the service results, the store terminal 160 outputs a receipt of the credit card service. By handing the receipt of the credit card use to the purchaser of the commodity, the store clerk completes the operations of the transmission of the credit card service request and the receipt of the service results in the ordinary store.

The operation of a user request transmitting operation to the present system when a commodity is purchased using a credit card on the Internet will be explained. A purchaser of a commodity makes a transmission S310 (service request transmission) for a service request of the credit card to the present system by using the user terminal 170 and the Internet store server 180. The information of service request includes a credit card number, name, date of use, store code, service form that is identification information as to shopping use or credit use, credit amount money and method of payment, which have been input by the purchaser of the commodity through the user terminal 170. At S320, upon receipt of the service request, the present system compares the service request, the store DB190 and the user DB130 with each other, and makes determinations to carry out processes which transmit the service results with respect to the service request to the store terminal 160. At S310, upon receipt of the service results, the Internet store server 180 transmits the service results to the user terminal 170. The purchaser of the commodity confirms the service results through the user terminal 170 to complete the operations of the transmission of the credit card service request and the receipt of the service results on the Internet.

The operations of the present system when the service request is received from the store terminal or the Internet store server will be explained with reference to FIGS. 5 and 6. Upon receipt of the service request at S500, the present system retrieves credit card numbers in the user DB130 for the credit card number corresponding to the service request at S510. As a result of the retrieval, when the credit card number does not exist, the present system edits the service results at the time of abnormal process at S570, carries out processes which transmit the service results to the service request end at S580, and when the credit card number exists, carries out a determining process S511 on the validity term.

At S511, the present system compares the service time and date of the service request with the validity term of the corresponding credit card number in the user DB130. As a result of the comparison, if the time and date of the service request comes after, the validity term, the present system edits the service results at the time of abnormal process at S570, carries out processes which transmit the results of the service to the service request end at S580, while, if the time and date of the service request comes before the validity term, it carries out a determining process S520 on the service forms.

At S512, it retrieves the store DB190 for the store code corresponding to the store code in the service request. As a result of the retrieval, if the corresponding store code does not exist, the present system edits the service results at the time of abnormal process at S570, carries out processes which transmit the service results to the service request end at S580, and when the store code exists, carries out a determining process S520 on the transaction form. At S520, a determining process is carried out as to whether the transaction form corresponding to the store code in the received service request relates to the Internet or any other (normal) transaction form.

As a result of the determination, when the transaction form relates to the Internet, a determination S530 is carried out on the Internet credit limit, and when the transaction form relates to any form other than the Internet (normal), a determination S610 is carried out on the normal credit limit.

At S530, the credit amount in the service request received is compared with the Internet credit limit corresponding to the store code in the service request. As a result of the comparison, when the credit amount exceeds the Internet credit limit, the present system edits the service results at the time of abnormal process at S570, carries out processes which transmit the service results to the service request end at S580, and when the credit amount is not more than the Internet credit limit, it carries out an updating process S540 on the Internet loam limit.

At S540, the present system sets an amount obtained by subtracting the credit amount from the Internet credit limit in the user DB130 as a new Internet credit limit updated after the credit card use, and at S541, registers information service history including the store code, service forms, credit amount money, method of payment and time and date in the service request at S541 in the user history DB191. The user DB191 is a data base that has been generated at S541 or S621 at the time of receipt of the initial service request. Thereafter, at S550, the present system edits the service results at the time of normal process, and carries out processes which transmit the service results to the service request end at S560.

For example, upon receipt of service requests including a credit card number “4999-1111-2222-3333”, name “Yamamoto”, a store code “1234”, a service form “shopping”, a credit amount “5,000”, a method of payment “lump-sum payment”, and service time and date “2001.3.20-13.00” in the initial state after the store conditions and service conditions have been registered, the present system carries out an updating process of the Internet credit limit in response to the service request, and in this case, the resulting user DB130 is represented by reference numeral 710. The Internet credit limit of the user DB130 has been updated from “10,000” to “5,000”.

For example, upon receipt of the service requests in the initial state after the store conditions and service conditions have been registered, the present system carries out an updating process of the user history, and in this case, the resulting user history DB191 is represented by reference numeral 800.

At S610, the credit amount in the received service request is compared with the normal credit limit corresponding the store code in the service request. As a result of the comparison, when the credit amount exceeds the normal credit limit, the present system edits the service results at the time of abnormal process at S650, carries out processes which transmit the service results to the service request end at S660, and when the credit amount is not more than the normal credit limit, it carries out an updating process S620 of the normal credit limit.

At S620, the present system carries out an updating process to set the amount obtained by subtracting the credit 5 amount from the normal credit limit in the user DB130 as a new normal credit limit after the use of the credit card, and at S620, it registers information service history including the store code, service forms, credit amount money, method of payment and time and date in the service request in the user history DB191. The user DB191 is a data base that has been generated at S541 or S621 at the time of receipt of the initial service request. Thereafter, at S630, the present system edits the service results at the time of normal process and carries out processes which transmit the service results to the service request end at S640.

For example, upon receipt of service requests including a credit card number “4999-1111-2222-3333”, name “Yamamoto”, a store code “5678”, a service form “shopping”, a credit amount “510,000”, a method of payment “divided payment of two times”, and service time and date “2001.3.20-18.00” in the initial state after the store conditions and service conditions have been registered, the present system carries out an updating process of the normal credit limit in response to the service request, and in this case, the resulting user DB130 is represented by reference numeral 720. The normal credit limit of the user DB130 has been updated from “600,000” to “90,000”.

For example, upon receipt of the service requests in the state after the process at 800, the present system carries out an updating process of the user history in accordance with the service requests, and in this case, the resulting user history DB191 is represented by reference numeral 810. The service history information corresponding to the store code “5678” has been added to the service history database DB191.

In the present embodiment, the transaction form has been explained as information corresponding to the store code, however, it is not necessarily set as information corresponding to the store code, and for example, the transaction form, as it is, may be set as connection state information that can be identified as to whether or not the Internet connection should be made on the network.

With respect to the aforementioned problem in which, since only one credit limit is managed in the conventional credit card, those who feel uneasy about the present security technique in the Internet or the like cannot use a card through the network without uneasiness even when the credit amount is small, the method of the present invention which sets the normal and Internet transaction forms or the like corresponding to the store codes, as well as setting a credit limit corresponding each of the transaction forms, and carries out a service request process based upon the credit limit so that the credit limit is set to a small amount at the time of the Internet transaction, thus, the resulting effect is that even those who feel uneasy about the present security technique in the Internet or the like can use a credit card within the small range of the credit limit without qualms.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A credit card management method comprising the steps of:
receiving credit card identification information and store identification information as well as a credit amount;
extracting a transaction form corresponding to the store identification information from a first storing unit which stores the transaction form corresponding to the store identification information;
extracting credit card identification information and a credit limit corresponding to the transaction form from a second storing unit which stores the credit card identification information and the credit limit corresponding to the transaction form; and
making a determination as to whether or not the credit amount is within the credit limit.

2. A program which allows a computer to execute the steps of:
receiving credit card identification information and store identification information as well as the credit amount;
extracting a transaction form corresponding to the store identification information from a first storing unit which stores the transaction form corresponding to the store identification information;
extracting credit card identification information and a credit limit corresponding to the transaction form from a second storing unit which stores the credit card identification information and the credit limit corresponding to the transaction form; and
making a determination as to whether or not the credit amount is within the credit limit.

3. A credit card management device comprising:
a first storing unit which stores transaction forms corresponding to store identification information;
a second storing unit which stores credit card identification information and a credit limit corresponding to the transaction form;
a unit which receives the credit card identification information and store identification information together with a credit amount;
a unit which extracts the transaction form corresponding to the store identification information from the first storing unit;
a unit which extracts credit card identification information and a credit limit corresponding to the transaction form from a second storing unit; and
a unit which makes a determination as to whether or not the credit amount is within the credit limit.

4. A computer readable recording medium which stores a program that executes the steps of:
receiving credit card identification information and store identification information as well as the credit amount;
extracting a transaction form corresponding to the store identification information from a first storing unit which stores the transaction form corresponding to the store identification information;
extracting credit card identification information and a credit limit corresponding to the transaction form from a second storing unit which stores the credit card identification information and the credit limit corresponding to the transaction form; and
making a determination as to whether or not the credit amount is within the credit limit.

5. A credit card management method comprising the steps of:
receiving credit card identification information and a transaction form as well as a credit amount;
extracting credit card identification information and a credit limit corresponding to the transaction form from a storing unit which stores the credit card identification information and the credit limit corresponding to the transaction form; and
making a determination as to whether or not the credit amount is within the credit limit.

6. A program which allows a computer to execute the steps of:
receiving credit card identification information and a transaction form as well as a credit amount;
extracting credit card identification information and a credit limit corresponding to the transaction form from a storing unit which stores the credit card identification information and the credit limit corresponding to the transaction form; and
making a determination as to whether or not the credit amount is within the credit limit.

7. A credit card management device comprising:
a unit which receives credit card identification information and a transaction form as well as a credit amount;
a unit which extracts credit card identification information and a credit limit corresponding to the transaction form from a storing unit which stores the credit card identification information and the credit limit corresponding to the transaction form; and
a unit which makes a determination as to whether or not the credit amount is within the credit limit.

8. A computer readable recording medium which stores a program that executes the steps of:
receiving credit card identification information and a transaction form as well as a credit amount;
extracting credit card identification information and a credit limit corresponding to the transaction form from a storing unit which stores the credit card identification information and the credit limit corresponding to the transaction form; and
making a determination as to whether or not the credit amount is within the credit limit.
